(19) United States
(12) Patent Application Publication
(10) Pub. No.: US 2025/0193256 A1
(43) Pub. Date: Jun. 12, 2025

(54) COMMUNICATION METHOD AND APPARATUS, TERMINAL, AND CORE NETWORK NODE

(71) Applicant: VIVO MOBILE COMMUNICATION CO., LTD., Dongguan (CN)

(72) Inventors: Sihan CHENG, Dongguan (CN); Xiaobo WU, Dongguan (CN)

(73) Assignee: VIVO MOBILE COMMUNICATION CO., LTD., Dongguan (CN)

(21) Appl. No.: 19/057,971

(22) Filed: Feb. 19, 2025

Related U.S. Application Data
(63) Continuation of application No. PCT/CN2023/113222, filed on Aug. 16, 2023.

(30) Foreign Application Priority Data
Aug. 22, 2022 (CN) 202211007515.5

(51) Int. Cl. H04L 65/1016; H04W 36/00; H04W 64/00

(52) U.S. Cl. CPC H04L 65/1016; H04W 36/0011; H04W 36/0064; H04W 64/003

(57) ABSTRACT

This application discloses a communication method and apparatus, a terminal, and a core network node. The communication method includes: when a terminal moves from a first access network node to a second access network node, determining, by the terminal, whether a target parameter of a first bearer matches a parameter of an Internet protocol multimedia system (IMS) session; and sending, by the terminal, a first message when the target parameter of the first bearer does not match the parameter of the IMS session, where the first message is used for requesting IMS session renegotiation; where the first access network node belongs to the N-th generation mobile communication technology, and the second access network node belongs to the M-th generation mobile communication technology, where N is greater than M.

### CROSS-REFERENCE TO RELATED APPLICATIONS

This application is a continuation of International Application No. PCT/CN2023/113222, filed Aug. 16, 2023, which claims priority to Chinese Patent Application No. 202211007515.5, filed Aug. 22, 2022. The entire contents of each of the above-referenced applications are expressly incorporated herein by reference.

### TECHNICAL FIELD

The application pertains to the field of communications technologies, and specifically, relates to a communication method and apparatus, a terminal, and a core network node.

### BACKGROUND

Commercialization of the 5^{th} Generation (5G) can bring better services to users. For example, Voice over New Radio (VoNR) can support a higher transmission rate, for example, a Guaranteed Bit Rate (GBR) or a Maximum Bit Rate (MBR) of voice supported by VoNR is 512 kilobits per second (kbps).

Voice over Long Term Evolution (VoLTE) belongs to the traditional 4th generation (4G) voice technology, and its maximum transmission rate is relatively low compared with VoNR. For example, a guaranteed bit rate GBR or MBR of voice supported by VoLTE is 128 kbps.

A user in a VoNR call in 5G needs to hand over or redirect to 4G in a case that a 5G signal becomes worse; however, because the 4G network does not support a rate of 512 kbps, a failure in handing over to 4G or redirecting to 4G may occur, which consequently leads to call drop of the user and affects user experience.

### SUMMARY

Embodiments of this application provide a communication method and apparatus, a terminal, and a core network node.

According to a first aspect, a communication method is provided, including:
in a case that a terminal moves from a first access network node to a second access network node, determining, by the terminal, whether a target parameter of a first bearer matches a parameter of an Internet protocol multimedia system IMS session; and
sending, by the terminal, a first message in a case that the target parameter of the first bearer does not match the parameter of the IMS session, where the first message is used for requesting IMS session renegotiation; where
the first access network node belongs to the N-th generation mobile communication technology, and the second access network node belongs to the M-th generation mobile communication technology, where N is greater than M.

According to a second aspect, a communication apparatus is provided, including:
a determining module, configured to: in a case that a terminal moves from a first access network node to a second access network node, determine whether a target parameter of a first bearer matches a parameter of an Internet protocol multimedia system IMS session; and
a first sending module, configured to send a first message in a case that the target parameter of the first bearer does not match the parameter of the IMS session, where the first message is used for requesting IMS session renegotiation; where
the first access network node belongs to the N-th generation mobile communication technology, and the second access network node belongs to the M-th generation mobile communication technology, where N is greater than M.

According to a third aspect, a communication method is provided, including:
in a case that a terminal moves from the N-th generation mobile communication technology to the M-th generation mobile communication technology, obtaining, by a first core network node, a first parameter of a first bearer of the terminal for the M-th generation mobile communication technology; and
in a case that the first parameter of the first bearer does not match a target parameter supported by the M-th generation mobile communication technology, modifying, by the first core network node, the first parameter of the first bearer into the target parameter; where
N is greater than M.

According to a fourth aspect, a communication apparatus is provided, including:
an obtaining module, configured to: in a case that a terminal moves from the N-th generation mobile communication technology to the M-th generation mobile communication technology, obtain a first parameter of a first bearer of the terminal for the M-th generation mobile communication technology; and
a modifying module, configured to: in a case that the first parameter of the first bearer does not match a target parameter supported by the M-th generation mobile communication technology, modify the first parameter of the first bearer into the target parameter; where
N is greater than M.

According to a fifth aspect, a communication method is provided, including:
in a case that a terminal moves from the N-th generation mobile communication technology to the M-th generation mobile communication technology, receiving, by a second core network node, a first message sent by a fourth core network node, where the first message is used for requesting a parameter of a first bearer of the terminal for the M-th generation mobile communication technology; and
sending, by the second core network node to the fourth core network node, a target parameter supportable by the M-th generation mobile communication technology corresponding to the first bearer; where
N is greater than M.

According to a sixth aspect, a communication apparatus is provided, including:
a first receiving module, configured to: in a case that a terminal moves from the N-th generation mobile communication technology to the M-th generation mobile communication technology, receive a first message sent by a fourth core network node, where the first message is used for requesting a parameter of a first bearer of the terminal for the M-th generation mobile communication technology; and
a second sending module, configured to send to the fourth core network node a target parameter supportable by the M-th generation mobile communication technology corresponding to the first bearer; where
N is greater than M.

According to a seventh aspect, a terminal is provided, where the terminal includes a processor and a memory, and a program or instructions capable of running on the processor are stored in the memory. When the program or the instructions are executed by the processor, the steps of the method according to the first aspect are implemented.

According to an eighth aspect, a terminal is provided, where the terminal includes a processor and a communication interface, where the processor is configured to: in a case that a terminal moves from a first access network node to a second access network node, determine whether a target parameter of a first bearer matches a parameter of an Internet protocol multimedia system IMS session; and the communication interface is configured to send a first message in a case that the target parameter of the first bearer does not match the parameter of the IMS session, where the first message is used for requesting IMS session renegotiation; where
the first access network node belongs to the N-th generation mobile communication technology, and the second access network node belongs to the M-th generation mobile communication technology, where N is greater than M.

According to a ninth aspect, a core network node is provided, where the core network node is a first core network node and includes a processor and a memory, and a program or instructions capable of running on the processor are stored in the memory. When the program or the instructions are executed by the processor, the steps of the method according to the third aspect are implemented.

According to a tenth aspect, a core network node is provided, where the core network node is a first core network node and includes a processor and a communication interface, where the processor is configured to: in a case that a terminal moves from the N-th generation mobile communication technology to the M-th generation mobile communication technology, obtain a first parameter of a first bearer of the terminal for the M-th generation mobile communication technology; and in a case that the first parameter of the first bearer does not match a target parameter supported by the M-th generation mobile communication technology, modify the first parameter of the first bearer into the target parameter; where
N is greater than M.

According to an eleventh aspect, a core network node is provided, where the core network node is a second core network node and includes a processor and a memory, and a program or instructions capable of running on the processor are stored in the memory. When the program or the instructions are executed by the processor, the steps of the method according to the fifth aspect are implemented.

According to a twelfth aspect, a core network node is provided, where the core network node is a second core network node and includes a processor and a communication interface, where the communication interface is configured to: in a case that a terminal moves from the N-th generation mobile communication technology to the M-th generation mobile communication technology, receive a first message sent by a fourth core network node, where the first message is used for requesting a parameter of a first bearer of the terminal for the M-th generation mobile communication technology; and send to the fourth core network node a target parameter supportable by the M-th generation mobile communication technology corresponding to the first bearer; where
N is greater than M.

According to a thirteenth aspect, a communication system is provided, including a terminal, a first core network node, and a second core network node, where the terminal can be configured to execute the steps of the communication method according to the first aspect, the first core network node can be configured to execute the steps of the communication method according to the third aspect, and the second core network node can be configured to execute the steps of the communication method according to the fifth aspect.

According to a fourteenth aspect, a readable storage medium is provided, where a program or instructions are stored in the readable storage medium. When the program or the instructions are executed by a processor, the steps of the method according to the first aspect, the third aspect, or the fifth aspect are implemented.

According to a fifteenth aspect, a chip is provided, where the chip includes a processor and a communication interface, the communication interface is coupled to the processor, and the processor is configured to run a program or instructions to implement the method according to the first aspect, the third aspect, or the fifth aspect.

According to a sixteenth aspect, a computer program/program product is provided, where the computer program/program product is stored in a storage medium, and the computer program/program product is executed by at least one processor to implement the steps of the method according to the first aspect, the third aspect, or the fifth aspect.

In the embodiments of this application, it is determined whether the target parameter of the first bearer matches the parameter of the IMS session in a case of moving from the first access network node to the second access network node; in a case that the target parameter of the first bearer does not match the parameter of the IMS session, the first message for requesting IMS session renegotiation is sent to make the parameter of the IMS session match the target parameter of the first bearer, thereby avoiding call drop in a case that the terminal moves from the first access network node to the second access network node.

### BRIEF DESCRIPTION OF DRAWINGS

FIG. 1 is a block diagram of a wireless communication system to which embodiments of this application are applicable;

FIG. 2 is a first schematic flowchart of a communication method according to an embodiment of this application;

FIG. 3 is a schematic flowchart of UE handing over from 5G to 4G;

FIG. 4 is a first schematic diagram of an internal processing process of a terminal;

FIG. 5 is a second schematic diagram of an internal processing process of a terminal;

FIG. 6 is a second schematic flowchart of a communication method according to an embodiment of this application;

FIG. 7 is a third schematic flowchart of a communication method according to this embodiment of this application;

FIG. 8 is a first schematic diagram of modules of a communication apparatus according to an embodiment of this application;

FIG. 9 is a schematic structural diagram of a terminal according to an embodiment of this application;

FIG. 10 is a second schematic diagram of modules of a communication apparatus according to an embodiment of this application;

FIG. 11 is a schematic structural diagram of an access network node according to an embodiment of this application;

FIG. 12 is a third schematic diagram of modules of a communication apparatus according to an embodiment of this application; and

FIG. 13 is a schematic structural diagram of a communication device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a Long Term Evolution (LTE) or LTE-Advanced (LTE-A) system, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other applications than an NR system application, for example, the 6^{th} Generation (6G) communication system.

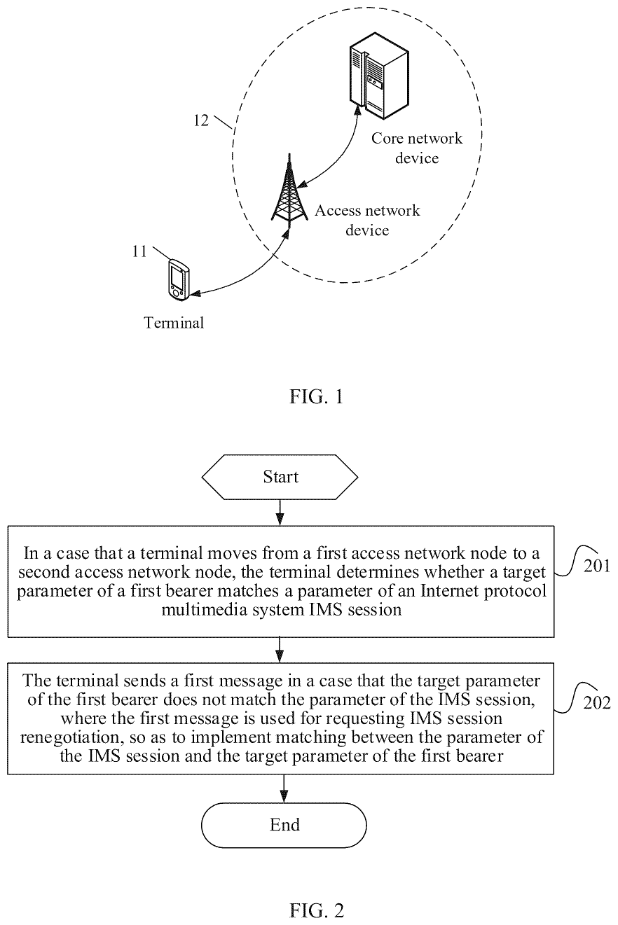

FIG. 1 is a block diagram of a wireless communication system to which the embodiments of this application are applicable. The wireless communication system includes a terminal 11 and a network-side device 12. The terminal 11 may be a mobile phone, a tablet computer, a laptop computer or notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, and the like. In addition to the foregoing terminal device, it may be a chip in a terminal, such as a modem chip or a system on chip (SoC). It should be noted that a specific type of the terminal 11 is not limited in the embodiments of this application. The network-side device 12 may include an access network device or a core network device, where the access network device may also be referred to as a radio access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a transmission and reception point (Transmitting Receiving Point, TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), or the like. It should be noted that, in the embodiments of this application, a core network device in an NR system is used as an example for description, and a specific type of the core network device is not limited.

The following describes a communication method and apparatus, a terminal, and a core network node provided in the embodiments of this application through specific embodiments and application scenarios thereof with reference to the accompanying drawings.

As shown in FIG. 2, an embodiment of this application provides a communication method, including:

Step 201: In a case that a terminal moves from a first access network node to a second access network node, the terminal determines whether a target parameter of a first bearer matches a parameter of an Internet protocol multimedia system IMS session.

Step 202: The terminal sends a first message in a case that the target parameter of the first bearer does not match the parameter of the IMS session, where the first message is used for requesting IMS session renegotiation.

It should be noted that the first message is used to implement matching between the parameter of the IMS session and the target parameter of the first bearer; and
the first access network node belongs to the N-th generation mobile communication technology, and the second access network node belongs to the M-th generation mobile communication technology, where N is greater than M.

It should be noted that, in this embodiment of this application, it is determined whether the target parameter of the first bearer matches the parameter of the IP Multimedia Subsystem (IMS) session in a case of moving from the first access network node to the second access network node; in a case that the target parameter of the first bearer does not match the parameter of the IMS session, the first message for requesting IMS session renegotiation is sent to make the parameter of the IMS session match the target parameter of the first bearer, thereby avoiding call drop in a case that the terminal moves from the first access network node to the second access network node.

It should be noted that the target parameter described in this embodiment of this application includes at least one of the following:
a maximum bit rate (MBR); or
a guaranteed bit rate (GBR).

In some embodiments, the first bearer is a bearer for transmitting a voice service or a video service.

It should be noted that the first bearer is used to transmit a voice service or a video service and the first bearer may be referred to as a voice bearer or a video bearer. The target parameter of the first bearer may be referred to as a target parameter of a voice service or a target parameter of a video service.

The first bearer may be a 5G quality of service (QoS) flow or a 4G Evolved Packet System (EPS) bearer.

When the first bearer is used to transmit a voice service, the first bearer is a bearer with a quality of service level of 1, for example, a QoS flow with 5QI (5G QoS Identifier, 5G quality of service identifier) being equal to 1 or an EPS bearer with a quality of service level identifier (QoS Class Identifier, QCI) being equal to 1.

The voice service in this application may be referred to as voice call service, and the video service may be referred to as video call service.

For example, in 4G, the terminal uses an EPS bearer to transmit a voice service of the terminal. A GBR supported in 4G is 128 kbps, and a GBR used by the terminal in 5G is 512 kbps. When the terminal moves from 5G to 4G, the GBRs used in 4G and 5G are different. In this case, the terminal needs to request IMS session renegotiation, so that two communication parties perform matching on the parameter used in an IMS session, that is, after IMS session renegotiation, the two communication parties use 128 kbps for voice service transmission.

It should be further noted that the terminal moving from the first access network node to the second access network node in this embodiment of this application includes one of the following:

S11: Hand over from the first access network node to the second access network node.

In this case, the terminal first receives a handover message sent by the first access network node, and then hands over to the second access network node based on the handover message.

The handover message may be a handover command message.

S12: Redirect from the first access network node to the second access network node.

In this case, the terminal first receives a redirection message sent by the first access network node, and then accesses the second access network node based on the redirection message.

The redirection message may be a Radio Resource Control (RRC) connection release message carrying a redirection indication.

In an embodiment of this application, a manner of obtaining the target parameter of the first bearer includes at least one of the following:

A11. The terminal receives the handover message sent by the first access network node, and obtains the target parameter of the first bearer from the handover message.

In some embodiments, the implementation in this case includes one of the following:

A111. When an Access Stratum (AS) of the terminal determines based on the handover message that the target parameter of the first bearer corresponding to the target service has been obtained, the target parameter of the first bearer is transmitted to the IMS layer of the terminal through a non-access stratum (NAS) of the terminal.

It should be noted that the target service described in this embodiment of this application is a voice service or a video service.

In this case, the AS stratum of the terminal processes the received handover message. After the AS stratum obtains GBRs or MBRs corresponding to multiple bearers based on a Data Radio Bearer (DRB) parameter (such as a Prioritized Bit Rate (PBR)), the AS stratum determines whether a DRB configuration corresponding to the target service is present. If so, a GBR or MBR of the first bearer corresponding to the target service is sent to the NAS stratum, the NAS stratum transmits the GBR or MBR of the first bearer corresponding to the target service to the IS layer, and the IS layer determines whether the target parameter of the first bearer matches the parameter of the IMS session.

A112. The AS stratum of the terminal transmits the target parameter of the first bearer obtained from the handover message to the NAS stratum, and the NAS stratum transmits the target parameter of the first bearer to the IMS layer when the first bearer is determined to be a bearer corresponding to the target service.

In this case, the AS stratum of the terminal processes the received handover message. After obtaining GBRs or MBRs corresponding to multiple bearers based on a DRB parameter (such as a prioritized bit rate), the AS stratum transmits the GBRs or MBRs corresponding to multiple bearers to the NAS stratum. The NAS stratum determines whether the first bearer corresponding to the target service is present; and if present, sends a GBR or MBR of the first bearer corresponding to the target service to the IMS layer, and the IS layer determines whether the target parameter of the first bearer matches the parameter of the IMS session

A12. The terminal receives a redirection message sent by the first access network node, accesses the second access network node based on the redirection message, and obtains the target parameter of the first bearer from a radio resource control RRC message sent by the second access network node.

For example, the RRC message may be an RRC connection reconfiguration message.

In some embodiments, the implementation in this case includes one of the following:

A121. In a case that the AS stratum of the terminal determines, based on the RRC message, that the target parameter of the first bearer corresponding to the target service has been obtained, the NAS stratum of the terminal transmits the target parameter of the first bearer to the IMS layer of the terminal.

In this case, the AS stratum of the terminal processes the received RRC message. After the AS stratum obtains GBRs or MBRs corresponding to multiple bearers based on a DRB parameter (such as prioritized bit rate), the AS stratum determines whether a DRB configuration corresponding to the target service is present. If so, a GBR or MBR of the first bearer corresponding to the target service is sent to the NAS stratum, the NAS stratum transmits the GBR or MBR of the first bearer corresponding to the target service to the IMS layer, and the IMS layer determines whether the target parameter of the first bearer matches the parameter of the IMS session.

A122. The AS stratum of the terminal transmits the target parameter of the first bearer obtained from the RRC message to the NAS stratum, and the NAS stratum transmits the target parameter of the first bearer to the IS layer in a case that the NAS stratum determines the first bearer to be a bearer corresponding to the target service.

In this case, the AS stratum of the terminal processes the received RRC message. After the AS stratum obtains GBRs or MBRs corresponding to multiple bearers based on a DRB parameter (such as a prioritized bit rate), the AS stratum determines whether the first bearer corresponding to the target service is present. If so, a GBR or MBR of the first bearer corresponding to the target service is sent to the IS layer, and the IMS layer determines whether the target parameter of the first bearer matches the parameter of the IMS session.

A13. The terminal receives first information sent by a first core network node corresponding to the second access network node, and obtains the target parameter of the first bearer based on the first information.

The first core network node is a core network node that provides a service for the terminal. The first core network node being corresponding to the second access network node means that the terminal is connected to the first core network node through the second access network node.

In some embodiments, in a case that the first information is used for determining by the terminal that the target parameter of the first bearer has changed, an implementation of obtaining the target parameter of the first bearer based on the first information includes:

A131. Obtain the target parameter of the first bearer from the handover message sent by the first access network node.

This implementation is suitable for a case that the terminal is handed over from the first access network node to the second access network node, and the handover message sent by the first access network node to the terminal carries the target parameter of the first bearer.

A132. Obtain the target parameter of the first bearer from the RRC message sent by the second access network node.

This implementation is suitable for a case that the terminal is redirected from the first access network node to the second access network node. After the terminal accesses the second access network node, the RRC message sent to the terminal by the second access network node carries the target parameter of the first bearer.

The first information may be explicit indication information, which is used to indicate that the target parameter of the first bearer has changed, for example, a GBR of a voice service changes; In some embodiments, the first information may be implicit indication information, and the UE needs to determine based on the first information that the target parameter of the first bearer have changed, for example, the GBR of the voice service has changed.

In some embodiments, in a case that the first information includes the target parameter of the first bearer, the obtaining the target parameter of the first bearer based on the first information includes: obtaining the target parameter of the first bearer from the first information.

That is, in this case, the target parameter of the first bearer is included in the first information.

In some embodiments, the implementation for obtaining the target parameter of the first bearer based on the first information is: receiving, by the NAS stratum of the terminal, the first information, obtaining the target parameter of the first bearer based on the first information, and transmitting the target parameter of the first bearer to the IMS layer.

Further, the implementation of receiving first information sent by a first core network node corresponding to the second access network node includes: sending a location update request to the first core network node, and receiving a location update acceptance message sent by the first core network node, where the location update acceptance message includes the first information.

For example, the location update request is a tracking area update (TAU) request or a registration request.

In some embodiments, the first core network node described in this embodiment of this application is a Mobility Management Entity (MME) that can directly send a message to the terminal.

A14. The terminal receives a first message for modifying the first bearer and sent by the first core network node corresponding to the second access network node, and obtains the target parameter of the first bearer from the first message.

It should be noted that the first message is usually sent by the second core network node through the first core network node, that is, the second core network node first sends the first message to the first core network node, and then the first core network node forwards the first message to the terminal. In some embodiments, the second core network node is a Session Management Function (SMF), a Packet Data Network Gateway (PGW), or a network element (namely SMF+PGW network element) implementing both the PGW and the SMF that can directly send a message to the first core network node.

In some embodiments, a further implementation in this case is receiving, by the NAS stratum of the terminal, the first message and transmitting the target parameter of the first bearer in the first message to the IMS layer.

To ensure continuity of voice or video call for the terminal accessing the second access network node, in at least one embodiment of this application, the target parameter of the first bearer needs to be first determined at the core network side, and for example, a first implementation manner is as follows:
in a case of knowing that the terminal has moved from the N-th generation mobile communication technology to the M-th generation mobile communication technology, the core network node may obtain the first parameter of the first bearer of the terminal for the M-th generation mobile communication technology; and modify the first parameter of the first bearer into the target parameter in a case that the first parameter of the first bearer does not match the target parameter supported by the M-th generation mobile communication technology.

In some embodiments, the first core network node modifies the first parameter of the first bearer into a target parameter corresponding to the access mode of the terminal.

In some embodiments, the first core network node modifies the first parameter of the first bearer into the target parameter in a case that it is determined that the first bearer is used for a target service.

In some embodiments, the first core network node further needs to send a session modification request to a third core network node, where the session modification request is used for modifying the first parameter of the first bearer into the target parameter.

It should be noted that the third core network node in this embodiment of this application is an SMF, a PGW, or an SMF+PGW network element implementing both the PGW and SMF functions.

In some embodiments, the second implementation is as follows:

In a case that the terminal moves from the N-th generation mobile communication technology to the M-th generation mobile communication technology, the second core network node receives a first message sent by a fourth core network node, where the first message is used for requesting a parameter of the first bearer of the terminal for the M-th generation mobile communication technology; and the second core network node sends to the fourth core network node a target parameter supportable by the M-th generation mobile communication technology corresponding to the first bearer.

Further, the second core network node obtains target radio access technology (RAT) information carried in the first message, and the second core network node sends, to the fourth core network node based on the target RAT information, a target parameter supportable by the M-th generation mobile communication technology corresponding to the target RAT information.

In some embodiments, the fourth core network node may be an Access and Mobility Management Function (AMF).

It should be noted that the second core network node needs to modify the parameter of the first bearer to the target parameter supportable by the M-th generation mobile communication technology, and the parameter of the first bearer obtained by the first core network node is the target parameter.

For example, when the N-th generation mobile communication technology is the 5G communication technology and the M-th generation mobile communication technology is the 4G communication technology, a GBR supported by the voice service of the terminal in 5G is 512 kbps. When the terminal moves from 5G to 4G, the second core network node directly maps the GBR of voice service to 512 kbps during parameter mapping. Because the GBR that can be supported in 4G is 128 kbps, the second core network node modifies the GBR of voice service to 128 kbps.

A difference between the two implementations mainly lies in that a network element that changes the parameter is different. In the first implementation, the parameter is changed by the MME, and in the second implementation, the parameter is changed by the SMF+PGW.

In some embodiments, in at least one embodiment of this application, the determining whether a target parameter of a first bearer matches a parameter of an Internet protocol multimedia system IMS session includes:
in a case that the first bearer corresponds to a target service, determining, by the terminal, whether the target parameter of the first bearer matches the parameter of the IMS session. The first bearer being corresponding to the target service is that the first bearer is used to transmit data of the target service, or the data of the target service is transmitted on the first bearer.

In some embodiments, the process of determining whether the target parameter of the first bearer matches the parameter of the Internet protocol multimedia system IMS session is performed by the terminal, and further, may be performed by the IMS layer of the terminal.

In some embodiments, a specific implementation of the determining, by the terminal or the IS layer of the terminal, whether the target parameter of the first bearer matches the parameter of the Internet protocol multimedia system IMS session includes:

Step 2011: Determine whether the target parameter of the first bearer and the parameter of the IMS session meet a first condition.

Step 2012: In a case that the first condition is met, determine that the target parameter of the first bearer matches the parameter of the IMS session, or in a case that the first condition is not met, determine that the target parameter of the first bearer does not match the parameter of the IMS session; where the first condition includes any one of the following:

C11. Whether an absolute value of a difference between the target parameter of the first bearer and the parameter of the IMS layer session is less than a first preset value.

In this case, in a case that the absolute value of the difference between the target parameter of the first bearer and the parameter of the IMS layer session is less than or equal to the first preset value, it indicates that the target parameter of the first bearer matches the parameter of the IMS layer session, and in a case that the absolute value of the difference between the target parameter of the first bearer and the parameter of the IMS layer session is greater than the first preset value, it indicates that the target parameter of the first bearer does not match the parameter of the IMS layer session.

In some embodiments, the first preset value may be configured by the network side, pre-configured by the terminal, or specified by the protocol.

C12. The target parameter of the first bearer is equal to the parameter of the IMS layer session.

In this case, in a case that the target parameter of the first bearer is equal to the parameter of the IMS layer session, it indicates that the target parameter of the first bearer matches the parameter of the IMS layer session, and in a case that the target parameter of the first bearer is not equal to the parameter of the IMS layer session, it indicates that the target parameter of the first bearer does not match the parameter of the IMS layer session.

C13. The difference between the target parameter of the first bearer and the parameter of the IMS layer session is a second preset value.

In this case, in a case that the difference between the target parameter of the first bearer and the parameter of the IMS layer session is the second preset value, it indicates that the target parameter of the first bearer matches the parameter of the IMS layer session, and in a case that the difference between the target parameter of the first bearer and the parameter of the IMS layer session is not the second preset value, it indicates that the target parameter of the first bearer does not match the parameter of the IMS layer session.

In some embodiments, the second preset value may be configured by the network side, pre-configured by the terminal, or specified by the protocol.

The following describes in detail a specific application of the above embodiments of this application.

### Application Case 1:

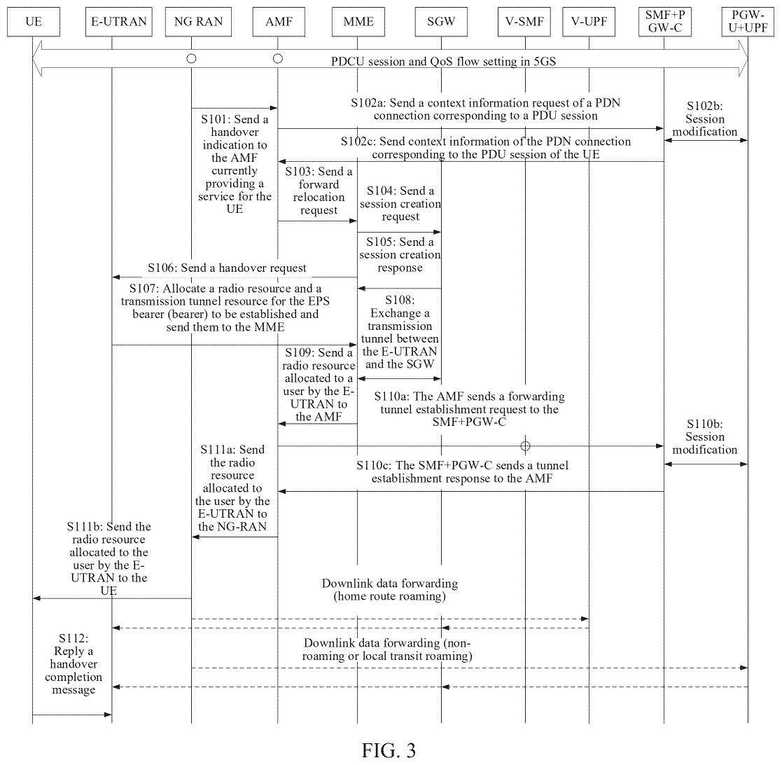

As shown in FIG. 3, the specific steps are as follows:

Step S101: A 5G base station (NG RAN) determines based on a measurement result reported by the UE to hand over the UE to 4G, and the NG RAN sends a handover indication to an AMF currently providing a service for the UE.

Step S102: The AMF requests context information of a PDN connection corresponding to a Protocol Data Unit (PDU) session of the UE from a network element (that is, SMF+PGW-C) providing a service for the UE and implementing both the control plane PGW and the SMF.

It should be noted that if the UE is in a roaming state, the request is sent to the SMF+PGW-C through the SMF that provides a service for the UE in a Visited Public Land Mobile Network (VPLMN).

It should be noted that if the UE is in a roaming state, the SMF+PGW-C may be located in a local public land mobile network (HPLMN) of the UE.

This step S102 includes the following steps:

Step S102a: The AMF sends, to the SMF+PGW-C, a context information request of the PDN connection corresponding to the PDU session.

Step S102b: The SMF+PGW-C implements session modification along with a network element (that is, the PGW-U+UPF) that implements both the user plane PGW and UPF.

Step S102c: The SMF+PGW-C sends context information of the PDN connection corresponding to the PDU session of the UE to the AMF.

In some embodiments, after the SMF+PGW-C receives the message of step S102a, when the SMF+PGW-C determines based on the message that the UE hands over to 4G, the SMF+PGW-C modifies the GBR or MBR corresponding to the voice bearer in the PDN connection to a parameter that can be supported by the PLMN and corresponding to a target access mode of the UE.

It should be noted that in this case, the subsequent processes are all executed according to the existing technology, and subsequently the MME obtains the modified information, so the MME does not need to modify the parameter.

In some embodiments, the AMF informs the SMF+PGW-C of target RAT information in step S102a, and the target RAT information is, for example, information about a normal base station or a satellite base station. The SMF+PGW-C determines a supported GBR or MBR based on the target RAT information.

After determining that the UE has handed over to 4G, the SMF+PGW-C initiates a PDN connection modification message, which is used for modifying the parameter of the NAS stratum of the bearer used for the voice service of the UE (for example, a GBR or MBR) to a supportable value.

Step S103: The AMF sends a forward relocation request to the MME, where the request includes the context information of the UE, including information about the PDN connection corresponding to the PDU session of the UE.

The information about the PDN connection includes information of an EPS bearer, for example, a GBR or an MBR of the EPS bearer.

In some embodiments, after receiving the forward relocation request sent by the AMF, if the MME determines that information about the EPS bearer is inconsistent with the parameter supported by an E-UTRAN, the information about the EPS bearer is modified to the parameter supported by the E-UTRAN. For example, the GBR or MBR of the EPS bearer is modified to a parameter supportable by the PLMN and corresponding to the current access mode of UE, for example, the parameter of the UE accessing through satellite is different from the parameter of accessing through the 4G base station. For example, only when the MME determines that the EPS bearer is used for a specific service (such as voice or video), modification is then performed, and for a non-specific service, it is directly rejected.

Step S104: The MME sends, to a Serving Gateway (SGW), a session creation request, which is used for creating a corresponding transmission tunnel for the EPS bearer.

Step S105: The SGW sends a session creation response to the MME.

In some embodiments, in a case that the MME modifies the information about the EPS bearer, the MME adds the modified GBR or MBR in step S104.

In some embodiments, in a case that the MME modifies the information about the EPS bearer, after step S105, the MME sends, to the SMF+PGW through the SGW, a session modification request, for modifying the GBR or MBR of the EPS bearer to the parameter supported by the E-UTRAN.

Step S106: The MME sends a handover request to the 4G base station E-UTRAN, where the handover request carries a parameter of an EPS bearer to be established;

Step S107: The E-UTRAN allocates a radio resource and a transmission tunnel resource for the EPS bearer to be established and sends them to the MME.

The radio resource includes a random access resource and a DRB resource.

It should be noted that each EPS bearer corresponds to one DRB.

Step S108: The MME exchanges a transmission tunnel between the E-UTRAN and the SGW with the SGW.

In some embodiments, the MME sends the transmission tunnel resource to the SGW, requesting to establish a transmission tunnel between the E-UTRAN and the SGW, and the SGW returns a transmission tunnel response to the MME.

Step S109: The MME sends to the AMF a radio resource allocated to the user by the E-UTRAN.

Step S110: If a priority of data cached by the UE in the NG RAN is relatively high, the AMF informs the SMF+PGW-C to establish a forwarding tunnel for forwarding the data of the UE from the NG RAN to the E-URTAN.

The step S110 includes the following steps:

Step S110a: The AMF sends a forwarding tunnel establishment request to the SMF+PGW-C.

Step S110b: The SMF+PGW-C and the PGW-U+UPF implement session modification.

Step S110c: The SMF+PGW-C sends a tunnel establishment response to the AMF.

Step S111: The AMF sends to the terminal a radio resource allocated to the user by the E-UTRAN.

For example, it is sent through a handover message (such as a handover command).

The step S111 includes the following steps:

Step S111a: The AMF sends to the NG-RAN the radio resource allocated to the user by the E-UTRAN.

Step S1l1b: The NG RAN sends to the UE the radio resource allocated to the user by the E-UTRAN.

In some embodiments, after receiving the handover message, the terminal determines whether the target parameter of the first bearer matches the parameter of the IMS session; and in a case that the target parameter of the first bearer does not match the parameter of the IMS session, sends a first message, where the first message is used for requesting IMS session renegotiation, so that the parameter of the IMS session matches the target parameter of the first bearer.

For example, the AS stratum of the terminal processes the handover message received in step S111b, and when obtaining the GBR or MBR parameter corresponding to each bearer based on the parameter of the DRB (such as a prioritized bit rate), the AS stratum may perform one of the following processes:

Process 1: The AS determines whether a DRB configuration corresponding to a specific service (for example, a voice service) is present, and if present, the GBR or MBR parameter corresponding to each bearer is sent to the NAS stratum, and then is forwarded by the NAS stratum to the IMS layer.

Process 2: The AS directly sends the GBR or MBR parameter corresponding to each bearer to the NAS stratum, and the NAS stratum determines whether an EPS bearer corresponding to a specific service is present, and if present, the NAS stratum sends the GBR or MBR parameter corresponding to the specific service to the IMS layer.

Further, if the IMS layer determines that the parameter of the bearer does not match the parameter of the IMS layer, the UE initiates an IMS session renegotiation request, and the session renegotiation request includes the IMS parameter corresponding to the parameter of the voice bearer.

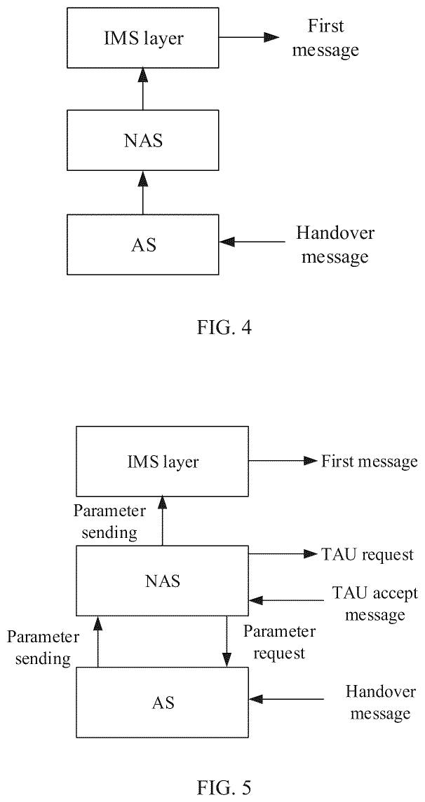

For example, when a NAS stratum of UE1 receives the handover message, the NAS stratum of UE1 sends the target parameter of the first bearer, such as a GBR or MBR, to an IMS layer of UE1, and the IMS layer of UE1 determines whether the target parameter of the first bearer matches the parameter of the IMS session. If not, UE1 initiates an IMS session renegotiation request (that is, UE1 sends a first message), where the IMS session renegotiation request includes the IMS session parameter corresponding to the target parameter of the first bearer, as shown in FIG. 4.

For example, the parameter negotiated by the IMS layer is 512 kbps, and the parameter obtained by the NAS stratum is 64 kbps. After the NAS stratum sends 64 kbps to the IMS layer, the IMS layer renegotiates with UE2 using 64 kbps, so that the two communication parties communicate with each other using 64 kbps.

In some embodiments, the IMS session renegotiation request may be a Session initialization Protocol (SIP) redirection (re-Invite) request or a SIP update request.

In step S112: The UE accesses the E-UTRAN based on a radio resource allocated by the E-UTRAN, and replies a handover completion message.

In some embodiments, if the terminal does not perform IMS session renegotiation before handing over to 4G, after the UE hands over to 4G, the UE sends a TAU request in 4G, and the MME carries the first information in a TAU accept message, where the first information is used to inform the UE that the parameter of the bearer of the UE is updated, and the NAS stratum of the UE obtains the parameter of the DRB from the AS stratum based on the indication information and sends it to the IMS layer. If the IMS layer determines that the parameter of the bearer does not match the parameter of the IMS layer, the UE initiates an IMS session renegotiation request, where the IMS session renegotiation request includes an IMS parameter corresponding to the parameter of the voice bearer. The processing process in the terminal is shown in FIG. 5.

It should be noted that in at least one embodiment of this application, the parameter of the supported bearer is determined based on the access network node after the terminal moves, and then IMS session renegotiation is performed. This can ensure that the communication service is uninterrupted after the terminal moves, and the communication reliability can be ensured.

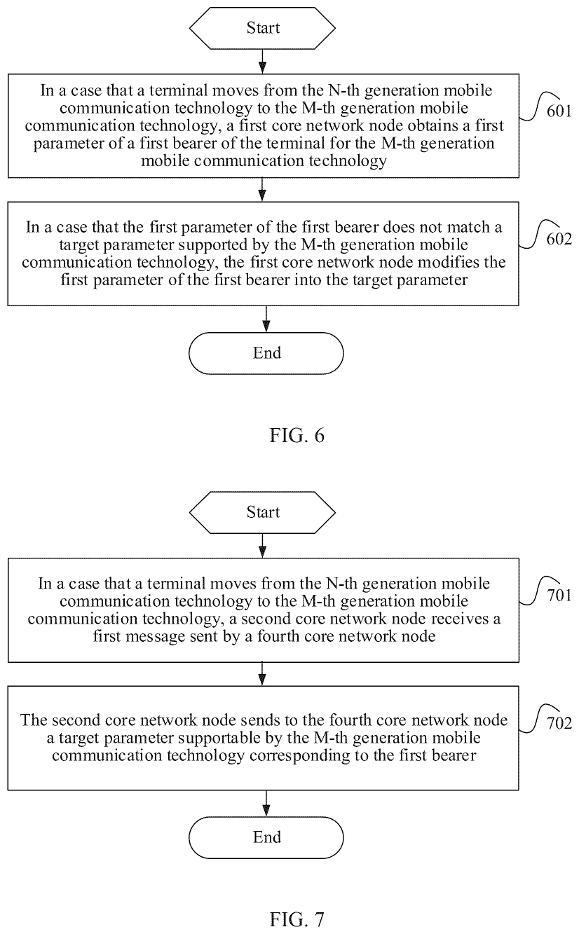

As shown in FIG. 6, an embodiment of this application provides a communication method, including:

Step 601: In a case that a terminal moves from the N-th generation mobile communication technology to the M-th generation mobile communication technology, a first core network node obtains a first parameter of a first bearer of the terminal for the M-th generation mobile communication technology.

Step 602: In a case that the first parameter of the first bearer does not match a target parameter supported by the M-th generation mobile communication technology, the first core network node modifies the first parameter of the first bearer into the target parameter; where
N is greater than M.

In some embodiments, the modifying the first parameter of the first bearer into the target parameter includes at least one of the following:
modifying, by the first core network node, the first parameter of the first bearer into a target parameter corresponding to an access mode of the terminal; or
modifying, by the first core network node, the first parameter of the first bearer into the target parameter in a case that it is determined that the first bearer is used for a target service.

In some embodiments, the method further includes:
sending, by the first core network node, a session modification request to a third core network node, where the session modification request is used for modifying the first parameter of the first bearer into the target parameter.

In some embodiments, the method further includes:
sending, by the first core network node, first information to the terminal; where
the first information satisfies at least one of the following:
the first information is used for determining by the terminal that the target parameter of the first bearer has changed; or
the first information includes the target parameter.

In some embodiments, the sending, by the first core network node, first information to the terminal includes:
receiving, by the first core network node, a location update request sent by the terminal; and
sending, by the first core network node, a location update acceptance message to the terminal, where the location update acceptance message includes the first information.

In some embodiments, the obtaining, by a first core network node, a first parameter of a first bearer of the terminal for the M-th generation mobile communication technology includes:
in a case that the first bearer corresponds to a target service, obtaining, by the first core network node, the first parameter of the first bearer of the terminal for the M-th generation mobile communication technology.

In some embodiments, the first bearer is a bearer for transmitting a voice service or a video service;
and/or
the target parameter includes at least one of the following:
a maximum bit rate MBR; or
a guaranteed bit rate GBR.

It should be noted that all the descriptions about the first core network node in the above embodiments are applicable to the embodiments of the communication method applied to the first core network node, with the same technical effects achieved. Details are not repeated here.

As shown in FIG. 7, an embodiment of this application provides a communication method, including:

Step 701: In a case that a terminal moves from the N-th generation mobile communication technology to the M-th generation mobile communication technology, a second core network node receives a first message sent by a fourth core network node, where the first message is used for requesting a parameter of a first bearer of the terminal for the M-th generation mobile communication technology.

Step 702: The second core network node sends to the fourth core network node a target parameter supportable by the M-th generation mobile communication technology corresponding to the first bearer; where
N is greater than M.

In some embodiments, the method further includes:
modifying, by the second core network node, the parameter of the first bearer to the target parameter supportable by the M-th generation mobile communication technology.

In some embodiments, the sending, by the second core network node to the fourth core network node, a target parameter supportable by the M-th generation mobile communication technology corresponding to the first bearer includes:
obtaining, by the second core network node, target radio access technology RAT information carried in the first message;
sending, by the second core network node to the fourth core network node based on the target RAT information, a target parameter supportable by the M-th generation mobile communication technology corresponding to the target RAT information.

In some embodiments, the method further includes:
sending, by the second core network node, a first message used for modifying the first bearer to the terminal through the first core network node, where the first message carries a target parameter of the first bearer.

In some embodiments, the sending, by the second core network node to the fourth core network node, a target parameter supportable by the M-th generation mobile communication technology corresponding to the first bearer includes:
in a case that the first bearer corresponds to a target service, sending, by the second core network node to the fourth core network node, a target parameter supportable by the M-th generation mobile communication technology corresponding to the first bearer.

In some embodiments, the second core network node includes one of the following:
a session management function SMF;
a packet data network gateway PGW; or
a network element capable of implementing a PGW and an SMF.

In some embodiments, the first bearer is a bearer for transmitting a voice service or a video service;
and/or
the target parameter includes at least one of the following:
a maximum bit rate MBR; or
a guaranteed bit rate GBR.

It should be noted that all the descriptions about the second core network node in the above embodiments are applicable to the embodiments of the communication method applied to the second core network node, with the same technical effects achieved. Details are not repeated here.

For the communication method provided in the embodiments of this application, the execution subject can be a communication apparatus. In the embodiments of this application, the communication apparatus provided in the embodiments of this application is described by using the communication method being executed by the communication apparatus as an example.

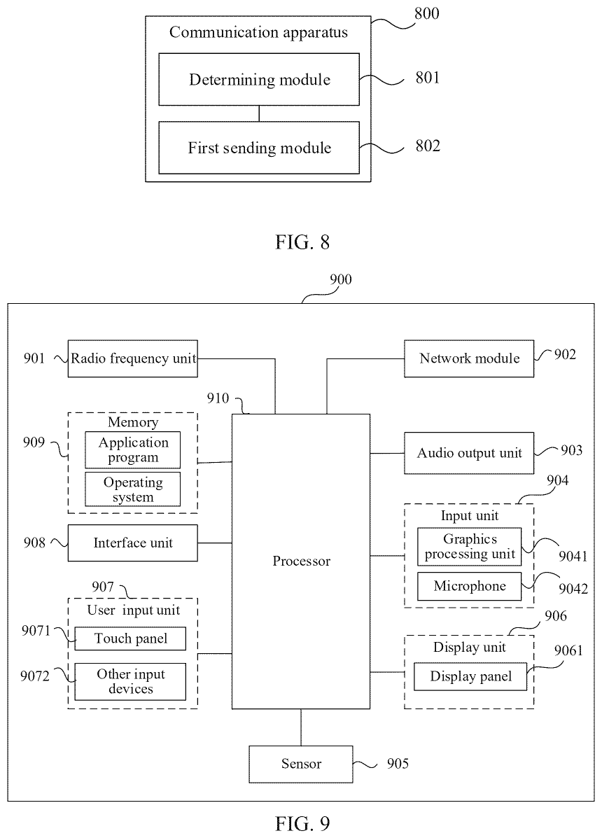

As shown in FIG. 8, a communication apparatus of an embodiment of this application is applied to a terminal, and includes:
a determining module 801, configured to: in a case that a terminal moves from a first access network node to a second access network node, determine whether a target parameter of a first bearer matches a parameter of an Internet protocol multimedia system IMS session; and
a first sending module 802, configured to send a first message in a case that the target parameter of the first bearer does not match the parameter of the IMS session, where the first message is used for requesting IMS session renegotiation; where
the first access network node belongs to the N-th generation mobile communication technology, and the second access network node belongs to the M-th generation mobile communication technology, where N is greater than M.

In some embodiments, a manner of obtaining the target parameter of the first bearer includes at least one of the following:
receiving a handover message sent by the first access network node, and obtaining the target parameter of the first bearer from the handover message;
receiving a redirection message sent by the first access network node, accessing the second access network node based on the redirection message, and obtaining the target parameter of the first bearer from a radio resource control RRC message sent by the second access network node;
receiving first information sent by a first core network node corresponding to the second access network node, and obtaining the target parameter of the first bearer based on the first information; or
receiving a first message for modifying the first bearer and sent by the first core network node corresponding to the second access network node, and obtaining the target parameter of the first bearer from the first message.

In some embodiments, an implementation of receiving a handover message sent by the first access network node, and obtaining the target parameter of the first bearer from the handover message includes one of the following:
in a case that an access stratum AS determines, based on the handover message, that a target parameter of a first bearer corresponding to a target service has been obtained, transmitting, by a non-access stratum NAS, the target parameter of the first bearer to the IMS layer; or
transmitting, by the AS stratum, the target parameter of the first bearer obtained from the handover message to the NAS stratum, and transmitting, by the NAS stratum, the target parameter of the first bearer to the IMS layer in a case that the NAS stratum determines the first bearer to be a bearer corresponding to the target service.

In some embodiments, an implementation of receiving a redirection message sent by the first access network node, accessing the second access network node based on the redirection message, and obtaining the target parameter of the first bearer from a radio resource control RRC message sent by the second access network node includes:
in a case that an AS stratum determines, based on the RRC message, that a target parameter of a first bearer corresponding to a target service has been obtained, transmitting, by a non-access stratum NAS, the target parameter of the first bearer to the IMS layer; or
transmitting, by the AS stratum, the target parameter of the first bearer obtained from the RRC message to the NAS stratum, and transmitting, by the NAS stratum, the target parameter of the first bearer to the IMS layer in a case that the NAS stratum determines the first bearer to be a bearer corresponding to the target service.

In some embodiments, an implementation of receiving first information sent by a first core network node corresponding to the second access network node, and obtaining the target parameter of the first bearer based on the first information includes:
receiving, by a non-access stratum NAS stratum, the first information, obtaining the target parameter of the first bearer based on the first information, and transmitting the target parameter of the first bearer to the IS layer.

In some embodiments, an implementation of receiving first information sent by a first core network node corresponding to the second access network node includes:
sending a location update request to the first core network node; and
receiving a location update acceptance message sent by the first core network node, where the location update acceptance message includes the first information.

In some embodiments, the location update request is a tracking area update TAU request or a registration request.

In some embodiments, in a case that the first information is used for determining by the terminal that the target parameter of the first bearer has changed, an implementation of obtaining the target parameter of the first bearer based on the first information includes:
obtaining the target parameter of the first bearer from the handover message sent by the first access network node; or
obtaining the target parameter of the first bearer from the RRC message sent by the second access network node.

In some embodiments, in a case that the first information includes the target parameter of the first bearer, an implementation of obtaining the target parameter of the first bearer based on the first information includes:
obtaining the target parameter of the first bearer from the first information.

In some embodiments, an implementation of receiving a first message for modifying the first bearer and sent by the first core network node corresponding to the second access network node, and obtaining the target parameter of the first bearer from the first message includes:
receiving, by a NAS stratum, the first message and transmitting the target parameter of the first bearer in the first message to the IMS layer.

In some embodiments, the redirection message is an RRC connection release message carrying a redirection indication.

In some embodiments, the first core network node is an access and mobility management entity MME.

In some embodiments, the determining module 801 is configured to:
in a case that the first bearer corresponds to a target service, determine whether the target parameter of the first bearer matches the parameter of the IMS session.

In some embodiments, the determining module 801 is configured to:
determine, by the IMS layer, whether the target parameter of the first bearer matches the parameter of the Internet protocol multimedia system IMS session.

In some embodiments, the determining module 801 includes:
a judging unit, configured to determine whether the target parameter of the first bearer and the parameter of the IMS session meet a first condition; and
a determining unit, configured to: in a case that the first condition is met, determine that the target parameter of the first bearer matches the parameter of the IMS session, or in a case that the first condition is not met, determine that the target parameter of the first bearer does not match the parameter of the IMS session; where
the first condition includes any one of the following:
whether an absolute value of a difference between the target parameter of the first bearer and the parameter of the IMS layer session is less than or equal to a first preset value;
the target parameter of the first bearer is equal to the parameter of the IMS layer session; or
the difference between the target parameter of the first bearer and the parameter of the IS layer session is a second preset value.

In some embodiments, the moving from a first access network node to a second access network node includes one of the following:
handing over from the first access network node to the second access network node; or
redirecting from the first access network node to the second access network node.

In some embodiments, the first bearer is a bearer for transmitting a voice service or a video service;
and/or
the target parameter includes at least one of the following:
a maximum bit rate MBR; or
a guaranteed bit rate GBR.

It should be noted that this apparatus embodiment corresponds to the method, and all implementations in the foregoing method embodiments are applicable to this apparatus embodiment, with the same technical effects achieved.

The communication apparatus in this embodiment of this application may be an electronic device, such as an electronic device with an operating system, or a component in the electronic device, such as an integrated circuit or a chip. The electronic device may be a terminal or other devices than the terminal. For example, the terminal may include, but is not limited to, the types of the terminal 11 listed above, and other devices may be a server, a Network Attached Storage (NAS), and the like. This is not limited in the embodiments of this application.

The communication apparatus provided in this embodiment of this application can implement the processes implemented in the method embodiment in FIG. 2, with the same technical effects achieved. To avoid repetition, details are not described herein again.

An embodiment of this application further provides a terminal, including a processor and a communication interface, where the processor is configured to: in a case that a terminal moves from a first access network node to a second access network node, determine whether a target parameter of a first bearer matches a parameter of an Internet protocol multimedia system IMS session; and the communication interface is configured to send a first message in a case that the target parameter of the first bearer does not match the parameter of the IMS session, where the first message is used for requesting IMS session renegotiation; where
the first access network node belongs to the N-th generation mobile communication technology, and the second access network node belongs to the M-th generation mobile communication technology, where N is greater than M.

In some embodiments, the communication interface is configured to implement at least one of the following:
receiving a handover message sent by the first access network node, and obtaining the target parameter of the first bearer from the handover message;
receiving a redirection message sent by the first access network node, accessing the second access network node based on the redirection message, and obtaining the target parameter of the first bearer from a radio resource control RRC message sent by the second access network node;
receiving first information sent by a first core network node corresponding to the second access network node, and obtaining the target parameter of the first bearer based on the first information; or
receiving a first message for modifying the first bearer and sent by the first core network node corresponding to the second access network node, and obtaining the target parameter of the first bearer from the first message.

In some embodiments, the communication interface is configured to implement:
in a case that an access stratum AS determines, based on the handover message, that a target parameter of a first bearer corresponding to a target service has been obtained, transmitting, by a non-access stratum NAS, the target parameter of the first bearer to the IMS layer; or
transmitting, by the AS stratum, the target parameter of the first bearer obtained from the handover message to the NAS stratum, and transmitting, by the NAS stratum, the target parameter of the first bearer to the IMS layer in a case that the NAS stratum determines the first bearer to be a bearer corresponding to the target service.

In some embodiments, the communication interface is configured to implement:
in a case that an AS stratum determines, based on the RRC message, that a target parameter of a first bearer corresponding to a target service has been obtained, transmitting, by a non-access stratum NAS, the target parameter of the first bearer to the IMS layer; or
transmitting, by the AS stratum, the target parameter of the first bearer obtained from the RRC message to the NAS stratum, and transmitting, by the NAS stratum, the target parameter of the first bearer to the IMS layer in a case that the NAS stratum determines the first bearer to be a bearer corresponding to the target service.

In some embodiments, the communication interface is configured to implement:
receiving, by a non-access stratum NAS stratum, the first information, obtaining the target parameter of the first bearer based on the first information, and transmitting the target parameter of the first bearer to the IMS layer.

In some embodiments, the communication interface is configured to implement:
sending a location update request to the first core network node; and
receiving a location update acceptance message sent by the first core network node, where the location update acceptance message includes the first information.

In some embodiments, the location update request is a tracking area update TAU request or a registration request.

In some embodiments, in a case that the first information is used for determining by the terminal that the target parameter of the first bearer has changed, the processor is configured to:
obtain the target parameter of the first bearer from the handover message sent by the first access network node; or
obtain the target parameter of the first bearer from the RRC message sent by the second access network node.

In some embodiments, in a case that the first information includes the target parameter of the first bearer, the processor is configured to:
obtain the target parameter of the first bearer from the first information.

In some embodiments, the communication interface is configured to:
receive, by a NAS stratum, the first message and transmit the target parameter of the first bearer in the first message to the IMS layer.

In some embodiments, the redirection message is an RRC connection release message carrying a redirection indication.

In some embodiments, the first core network node is an access and mobility management entity MME.

In some embodiments, the communication interface is configured to:
in a case that the first bearer corresponds to a target service, determine whether the target parameter of the first bearer matches the parameter of the IMS session.

In some embodiments, the communication interface is configured to:
determine, by the IMS layer, whether the target parameter of the first bearer matches the parameter of the Internet protocol multimedia system IMS session.

In some embodiments, the communication interface is configured to:
determine whether the target parameter of the first bearer and the parameter of the IMS session meet a first condition; and
in a case that the first condition is met, determine that the target parameter of the first bearer matches the parameter of the IMS session, or in a case that the first condition is not met, determine that the target parameter of the first bearer does not match the parameter of the IMS session; where
the first condition includes any one of the following:
whether an absolute value of a difference between the target parameter of the first bearer and the parameter of the IMS layer session is less than or equal to a first preset value;
the target parameter of the first bearer is equal to the parameter of the IMS layer session; or
the difference between the target parameter of the first bearer and the parameter of the IMS layer session is a second preset value.

In some embodiments, the moving from a first access network node to a second access network node includes one of the following:
handing over from the first access network node to the second access network node; or
redirecting from the first access network node to the second access network node.

In some embodiments, the first bearer is a bearer for transmitting a voice service or a video service;
and/or
the target parameter includes at least one of the following:
a maximum bit rate MBR; or
a guaranteed bit rate GBR.

The terminal embodiment corresponds to the foregoing terminal side method embodiment, and the implementation processes and implementations of the foregoing method embodiments can be applied to the terminal embodiments, with the same technical effects achieved. FIG. 9 is a schematic diagram of a hardware structure of a terminal implementing an embodiment of this application.

The terminal 900 includes but is not limited to at least part of components such as a radio frequency unit 901, a network module 902, an audio output unit 903, an input unit 904, a sensor 905, a display unit 906, a user input unit 907, an interface unit 908, a memory 909, and a processor 910.

Persons skilled in the art can understand that the terminal 900 may further include a power supply (for example, a battery) supplying power to the components, and the power supply may be logically connected to the processor 910 through a power management system. In this way, functions such as charge management, discharge management, and power consumption management are implemented by using the power management system. The structure of the terminal shown in FIG. 9 does not constitute any limitation on the terminal. The terminal may include more or fewer components than shown in the figure, or a combination of some components, or the components disposed differently. Details are not described herein again.

It can be understood that in this embodiment of this application, the input unit 904 may include a Graphics Processing Unit (GPU) 9041 and a microphone 9042. The graphics processing unit 9041 processes image data of a still picture or video obtained by an image capture apparatus (such as a camera) in a video capture mode or an image capture mode. The display unit 906 may include a display panel 9061, and the display panel 9061 may be configured in a form of a liquid crystal display, an organic light-emitting diode, and the like. The user input unit 907 includes at least one of a touch panel 9071 or other input devices 9072. The touch panel 9071 is also referred to as a touchscreen. The touch panel 9071 may include two parts: a touch detection apparatus and a touch controller. The other input devices 9072 may include but are not limited to a physical keyboard, a function key (such as a volume control key or a power on/off key), a trackball, a mouse, a joystick, and the like. Details are not described herein.

In this embodiment of this application, after receiving downlink data from a network-side device, the radio frequency unit 901 sends the downlink data to the processor 910 for processing; and the radio frequency unit 901 also sends uplink data to the network-side device. Generally, the radio frequency unit 901 includes, but is not limited to, an antenna, an amplifier, a transceiver, a coupler, a low noise amplifier, a duplexer, and the like.

The memory 909 may be configured to store software programs or instructions and various data. The memory 909 may mainly include a first storage area for storing programs or instructions and a second storage area for storing data, where the first storage area may store an operating system, an application program or instructions required by at least one function (for example, an audio playing function and an image playing function), and the like. In addition, the memory 909 may be a volatile memory or a non-volatile memory, or the memory 909 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 909 described in this embodiment this application includes but is not limited to these and any other suitable types of memories.

The processor 910 may include one or more processing units. In some embodiments, the processor 910 integrates an application processor and a modem processor. The application processor mainly processes operations related to an operating system, a user interface, an application program, and the like. The modem processor mainly processes wireless communication signals, for example, a baseband processor. It should be understood that, the modem processor may not be integrated into the processor 910.

The processor 910 is configured to:
in a case that a terminal moves from a first access network node to a second access network node, determine whether a target parameter of a first bearer matches a parameter of an Internet protocol multimedia system IMS session; and
the radio frequency unit 901 is configured to: send a first message in a case that the target parameter of the first bearer does not match the parameter of the IMS session, where the first message is used for requesting IMS session renegotiation; where
the first access network node belongs to the N-th generation mobile communication technology, and the second access network node belongs to the M-th generation mobile communication technology, where N is greater than M.

In some embodiments, the radio frequency unit 901 is configured to implement at least one of the following:
receiving a handover message sent by the first access network node, and obtaining the target parameter of the first bearer from the handover message;
receiving a redirection message sent by the first access network node, accessing the second access network node based on the redirection message, and obtaining the target parameter of the first bearer from a radio resource control RRC message sent by the second access network node;
receiving first information sent by a first core network node corresponding to the second access network node, and obtaining the target parameter of the first bearer based on the first information; or
receiving a first message for modifying the first bearer and sent by the first core network node corresponding to the second access network node, and obtaining the target parameter of the first bearer from the first message.

In some embodiments, the radio frequency unit 901 is configured to:
in a case that an access stratum AS determines, based on the handover message, that a target parameter of a first bearer corresponding to a target service has been obtained, transmit, by a non-access stratum NAS, the target parameter of the first bearer to the IMS layer; or
transmit, by the AS stratum, the target parameter of the first bearer obtained from the handover message to the NAS stratum, and transmit, by the NAS stratum, the target parameter of the first bearer to the IMS layer in a case that the NAS stratum determines the first bearer to be a bearer corresponding to the target service.

In some embodiments, an implementation of receiving a redirection message sent by the first access network node, accessing the second access network node based on the redirection message, and obtaining the target parameter of the first bearer from a radio resource control RRC message sent by the second access network node includes:
in a case that an AS stratum determines, based on the RRC message, that a target parameter of a first bearer corresponding to a target service has been obtained, transmitting, by a non-access stratum NAS, the target parameter of the first bearer to the IMS layer; or
transmitting, by the AS stratum, the target parameter of the first bearer obtained from the RRC message to the NAS stratum, and transmitting, by the NAS stratum, the target parameter of the first bearer to the IS layer in a case that the NAS stratum determines the first bearer to be a bearer corresponding to the target service.

In some embodiments, the radio frequency unit 901 is configured to:
receive, by a non-access stratum NAS stratum, the first information, obtain the target parameter of the first bearer based on the first information, and transmit the target parameter of the first bearer to the IMS layer.

In some embodiments, the radio frequency unit 901 is configured to:
send a location update request to the first core network node; and
receiving a location update acceptance message sent by the first core network node, where the location update acceptance message includes the first information.

In some embodiments, the location update request is a tracking area update TAU request or a registration request.

In some embodiments, in a case that the first information is used for determining by the terminal that the target parameter of the first bearer has changed, the processor 910 is configured to:
obtain the target parameter of the first bearer from the handover message sent by the first access network node; or
obtain the target parameter of the first bearer from the RRC message sent by the second access network node.

In some embodiments, in a case that the first information includes the target parameter of the first bearer, the processor 910 is configured to:
obtain the target parameter of the first bearer from the first information.

In some embodiments, the radio frequency unit 901 is configured to:
receive, by a NAS stratum, the first message and transmit the target parameter of the first bearer in the first message to the IMS layer.

In some embodiments, the redirection message is an RRC connection release message carrying a redirection indication.

In some embodiments, the first core network node is an access and mobility management entity MME.

In some embodiments, the processor 910 is configured to:
in a case that the first bearer corresponds to a target service, determine whether the target parameter of the first bearer matches the parameter of the IMS session.

In some embodiments, the processor 910 is configured to:
determine, by the IMS layer, whether the target parameter of the first bearer matches the parameter of the Internet protocol multimedia system IMS session.

In some embodiments, the processor 910 is configured to:
determine whether the target parameter of the first bearer and the parameter of the IMS session meet a first condition; and
in a case that the first condition is met, determine that the target parameter of the first bearer matches the parameter of the IMS session, or in a case that the first condition is not met, determine that the target parameter of the first bearer does not match the parameter of the IMS session; where
the first condition includes any one of the following:
whether an absolute value of a difference between the target parameter of the first bearer and the parameter of the IS layer session is less than or equal to a first preset value;
the target parameter of the first bearer is equal to the parameter of the IMS layer session; or
the difference between the target parameter of the first bearer and the parameter of the IMS layer session is a second preset value.

In some embodiments, the moving from a first access network node to a second access network node includes one of the following:
handing over from the first access network node to the second access network node; or
redirecting from the first access network node to the second access network node.

In some embodiments, the first bearer is a bearer for transmitting a voice service or a video service;
and/or
the target parameter includes at least one of the following:
a maximum bit rate MBR; or
a guaranteed bit rate GBR.

An embodiment of this application further provides a terminal, including a processor and a memory, where a program or instructions capable of running on the processor are stored in the memory, and when the program or the instructions are executed by the processor, the processes of the foregoing embodiments of the communication method are implemented, with the same technical effects achieved. To avoid repetition, details are not described herein again.

An embodiment of this application further provides a readable storage medium, where the computer readable storage medium stores a program or instructions, and when the program or the instructions are executed by a processor, the processes of the foregoing embodiments of the communication method are implemented, with the same technical effects achieved. To avoid repetition, details are not described herein again.

For example, the computer-readable storage medium is a Read-Only Memory (ROM), a Random Access Memory (RAM), a magnetic disk, an optical disc, or the like.

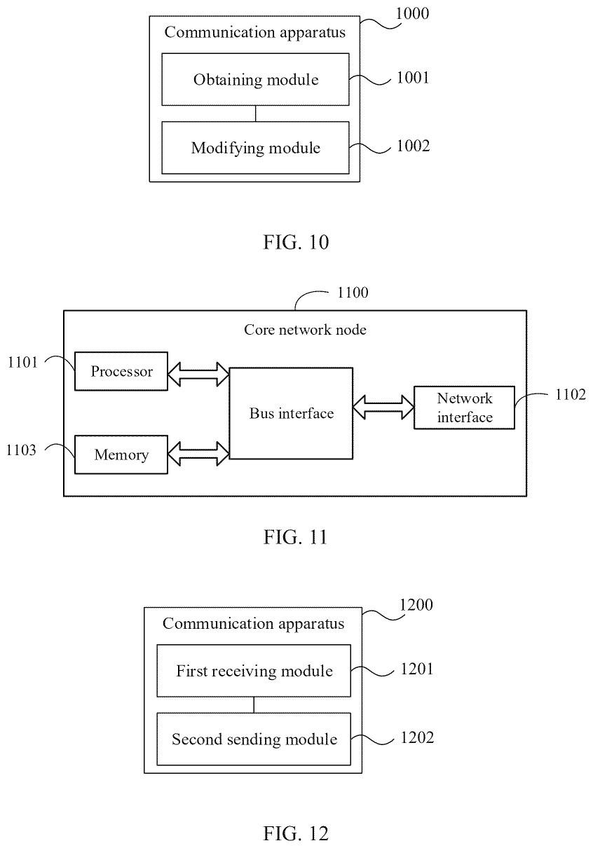

As shown in FIG. 10, an embodiment of this application further provides a communication apparatus 1000, applied to a first core network node and includes:
an obtaining module 1001, configured to: in a case that a terminal moves from the N-th generation mobile communication technology to the M-th generation mobile communication technology, obtain a first parameter of a first bearer of the terminal for the M-th generation mobile communication technology; and
a modifying module 1002, configured to: in a case that the first parameter of the first bearer does not match a target parameter supported by the M-th generation mobile communication technology, modify the first parameter of the first bearer into the target parameter; where
N is greater than M.

In some embodiments, the modifying module 1002 is configured to implement at least one of the following:
modifying the first parameter of the first bearer into a target parameter corresponding to an access mode of the terminal; or
modifying the first parameter of the first bearer into the target parameter in a case that it is determined that the first bearer is used for a target service.

In some embodiments, the apparatus further includes:
a third sending module, configured to send a session modification request to a third core network node, where the session modification request is used for modifying the first parameter of the first bearer into the target parameter.

In some embodiments, the apparatus further includes:
a fourth sending module, configured to send first information to the terminal, where
the first information satisfies at least one of the following:
the first information is used for determining by the terminal that the target parameter of the first bearer has changed; or
the first information includes the target parameter.

In some embodiments, the fourth sending module includes:
a receiving unit, configured to receive a location update request sent by the terminal; and
a first sending unit, configured to send a location update acceptance message to the terminal, where the location update acceptance message includes the first information.

In some embodiments, the obtaining module 1001 is configured to:
in a case that the first bearer corresponds to a target service, obtain the first parameter of the first bearer of the terminal for the M-th generation mobile communication technology.

In some embodiments, the first bearer is a bearer for transmitting a voice service or a video service;
and/or
the target parameter includes at least one of the following:
a maximum bit rate MBR; or
a guaranteed bit rate GBR.

It should be noted that this apparatus embodiment corresponds to the apparatus, and all implementations in the foregoing method embodiments are applicable to this apparatus embodiment, with the same technical effects achieved. Details are not repeated here.

An embodiment of this application further provides a core network node, where the core network node is a first core network node and includes a processor and a communication interface, where the processor is configured to: in a case that a terminal moves from the N-th generation mobile communication technology to the M-th generation mobile communication technology, obtain a first parameter of a first bearer of the terminal for the M-th generation mobile communication technology; and
in a case that the first parameter of the first bearer does not match a target parameter supported by the M-th generation mobile communication technology, modify the first parameter of the first bearer into the target parameter; where
N is greater than M.

In some embodiments, the processor is configured to implement at least one of the following:
modifying the first parameter of the first bearer into a target parameter corresponding to an access mode of the terminal; or
modifying the first parameter of the first bearer into the target parameter in a case that it is determined that the first bearer is used for a target service.

In some embodiments, the communication interface is configured to:
send a session modification request to a third core network node, where the session modification request is used for modifying the first parameter of the first bearer into the target parameter.

In some embodiments, the communication interface is configured to:
send first information to the terminal, where
the first information satisfies at least one of the following:
the first information is used for determining by the terminal that the target parameter of the first bearer has changed; or
the first information includes the target parameter.

In some embodiments, the communication interface is configured to:
receive, a location update request sent by the terminal; and
send a location update acceptance message to the terminal, where the location update acceptance message includes the first information.

In some embodiments, the processor is configured to:
in a case that the first bearer corresponds to a target service, obtain the first parameter of the first bearer of the terminal for the M-th generation mobile communication technology.

In some embodiments, the first bearer is a bearer for transmitting a voice service or a video service;
and/or
the target parameter includes at least one of the following:
a maximum bit rate MBR; or
a guaranteed bit rate GBR.

An embodiment of this application further provides a core network node, where the core network node is a first core network node, including a processor and a memory, where a program or instructions capable of running on the processor are stored in the memory, and when the program or the instructions are executed by the processor, the processes of the foregoing embodiments of the communication method are implemented, with the same technical effects achieved. To avoid repetition, details are not described herein again.

An embodiment of this application further provides a core network node, where the core network node is a first core network node. As shown in FIG. 11, the core network node 1100 includes a processor 1101, a network interface 1102, and a memory 1103. The network interface 1102 is, for example, a common public radio interface (CPRI).

The core network node 1100 according to this embodiment of this application further includes instructions or programs stored in the memory 1103 and capable of running on the processor 1101, and the processor 1101 calls the instructions or programs in the memory 1103 to execute the methods performed by the modules shown in FIG. 10, with the same technical effects achieved. To avoid repetition, details are not described herein again.

An embodiment of this application further provides a readable storage medium, where the readable storage medium stores a program or instructions, and when the program or the instructions are executed by a processor, the processes of the foregoing embodiments of the communication method are implemented, with the same technical effects achieved. To avoid repetition, details are not described herein again.

The processor is a processor in the network-side device in the foregoing embodiment. The readable storage medium includes a computer-readable storage medium, for example, a computer read only memory ROM, a random access memory RAM, a magnetic disk, or an optical disc.

As shown in FIG. 12, an embodiment of this application further provides a communication apparatus 1200, applied to a second core network node and includes:
a first receiving module 1201, configured to: in a case that a terminal moves from the N-th generation mobile communication technology to the M-th generation mobile communication technology, receive a first message sent by a fourth core network node, where the first message is used for requesting a parameter of a first bearer of the terminal for the M-th generation mobile communication technology; and
a second sending module 1202, configured to send to the fourth core network node a target parameter supportable by the M-th generation mobile communication technology corresponding to the first bearer; where
N is greater than M.

In some embodiments, the apparatus further includes:
a parameter modification module, configured to modify the parameter of the first bearer to the target parameter supportable by the M-th generation mobile communication technology.

In some embodiments, the second sending module 1202 includes:
an obtaining unit, configured to obtain target radio access technology RAT information carried in the first message; and
a second sending unit, configured to send, to the fourth core network node based on the target RAT information, a target parameter supportable by the M-th generation mobile communication technology corresponding to the target RAT information.

In some embodiments, the apparatus further includes:
a fifth sending module, configured to send a first message used for modifying the first bearer to the terminal through the first core network node, where the first message carries a target parameter of the first bearer.

In some embodiments, the second sending module 1202 is configured to:
in a case that the first bearer corresponds to a target service, send to the fourth core network node a target parameter supportable by the M-th generation mobile communication technology corresponding to the first bearer.

In some embodiments, the second core network node includes one of the following:
a session management function SMF;
a packet data network gateway PGW; or
a network element capable of implementing a PGW and an SMF.

In some embodiments, the first bearer is a bearer for transmitting a voice service or a video service;
and/or
the target parameter includes at least one of the following:
a maximum bit rate MBR; or
a guaranteed bit rate GBR.

It should be noted that this apparatus embodiment corresponds to the apparatus, and all implementations in the foregoing method embodiments are applicable to this apparatus embodiment, with the same technical effects achieved. Details are not repeated here.

An embodiment of this application further provides a core network node, where the core network node is a second core network node and includes a processor and a communication interface, where the communication interface is configured to: in a case that a terminal moves from the N-th generation mobile communication technology to the M-th generation mobile communication technology, receive a first message sent by a fourth core network node, where the first message is used for requesting a parameter of a first bearer of the terminal for the M-th generation mobile communication technology; and send to the fourth core network node a target parameter supportable by the M-th generation mobile communication technology corresponding to the first bearer; where
N is greater than M.

In some embodiments, the processor is configured to:
modify the parameter of the first bearer to the target parameter supportable by the M-th generation mobile communication technology.

In some embodiments, the processor is configured to:
obtain target radio access technology RAT information carried in the first message; and
The communication interface is configured to send, to the fourth core network node based on the target RAT information, a target parameter supportable by the M-th generation mobile communication technology corresponding to the target RAT information.

In some embodiments, the communication interface is further configured to:
send a first message used for modifying the first bearer to the terminal through the first core network node, where the first message carries a target parameter of the first bearer.

In some embodiments, the communication interface is configured to:
in a case that the first bearer corresponds to a target service, send to the fourth core network node a target parameter supportable by the M-th generation mobile communication technology corresponding to the first bearer.

In some embodiments, the second core network node includes one of the following:
a session management function SMF;
a packet data network gateway PGW; or
a network element capable of implementing a PGW and an SMF.

In some embodiments, the first bearer is a bearer for transmitting a voice service or a video service;
and/or
the target parameter includes at least one of the following:
a maximum bit rate MBR; or
a guaranteed bit rate GBR.

An embodiment of this application further provides a core network node, where the core network node is a second core network node, including a processor and a memory, where a program or instructions capable of running on the processor are stored in the memory, and when the program or the instructions are executed by the processor, the processes of the foregoing embodiments of the communication method are implemented, with the same technical effects achieved. To avoid repetition, details are not described herein again.

An embodiment of this application further provides a core network node, where the core network node is a second core network node. For the structure of the second core network node, refer to the structure of the core network node shown in FIG. 11. Details are not repeated here.

The second core network node in this embodiment of this application further includes instructions or programs stored in the memory and capable of running on the processor, and the processor calls the instructions or programs in the memory to execute the methods performed by the modules shown in FIG. 12, with the same technical effects achieved. To avoid repetition, details are not described herein again.

An embodiment of this application further provides a readable storage medium, where the readable storage medium stores a program or instructions, and when the program or the instructions are executed by a processor, the processes of the foregoing embodiments of the communication method are implemented, with the same technical effects achieved. To avoid repetition, details are not described herein again.

The processor is a processor in the network-side device in the foregoing embodiment. The readable storage medium includes computer readable storage medium, such as computer read-only memory ROM, random access memory RAM, magnetic disk or optical disk, etc.

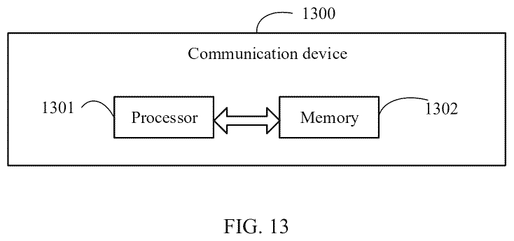

As shown in FIG. 13, an embodiment of this application further provides a communication device 1300, including a processor 1301 and a memory 1302. A program or instructions capable of running on the processor 1301 are stored in the memory 1302. For example, when the communication device 1300 is a terminal and when the program or the instructions are executed by the processor 1301, the steps of the foregoing embodiments of the communication method are implemented, with the same technical effects achieved When the communication device 1300 is a first core network node and when the program or the instructions are executed by the processor 1301, the steps of the foregoing embodiments of the communication method are implemented, with the same technical effects achieved. When the communication device 1300 is a second core network node and when the program or the instructions are executed by the processor 1301, the steps of the foregoing embodiments of the communication method are implemented, with the same technical effects achieved. To avoid repetition, details are not described herein again.

An embodiment of this application further provides a chip. The chip includes a processor and a communication interface. The communication interface is coupled to the processor. The processor is configured to run a program or instructions to implement the processes of the foregoing embodiments of the communication method, with the same technical effect achieved. To avoid repetition, details are not described herein again.

It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a storage medium, and when being executed by at least one processor, the computer program/program product is configured to implement the processes of the foregoing embodiments of the communication method, with the same technical effects achieved. To avoid repetition, details are not repeated herein.

An embodiment of this application further provides a communication system, including a terminal, a first core network node, and a second core network node, where the terminal can be configured to execute the steps of the communication method described above, the first core network node can be configured to execute the steps of the communication method described above, and the second core network node can be configured to execute the steps of the communication method described above.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiment may be implemented by software with a necessary general hardware platform. The method in the foregoing embodiment may also be implemented by hardware. Based on such an understanding, the technical solutions of the present application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this disclosure.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A communication method, comprising:
when a terminal moves from a first access network node to a second access network node, determining, by the terminal, whether a target parameter of a first bearer matches a parameter of an Internet protocol multimedia system (IS) session; and
sending, by the terminal, a first message when the target parameter of the first bearer does not match the parameter of the IMS session, wherein the first message is used for requesting IMS session renegotiation,
wherein the first access network node belongs to N-th generation mobile communication technology, and the second access network node belongs to M-th generation mobile communication technology, wherein N is greater than M.

2. The communication method according to claim 1, wherein a manner of obtaining the target parameter of the first bearer comprises at least one of the following:
receiving, by the terminal, a handover message sent by the first access network node, and obtaining the target parameter of the first bearer from the handover message;
receiving, by the terminal, a redirection message sent by the first access network node, accessing the second access network node based on the redirection message, and obtaining the target parameter of the first bearer from a radio resource control (RRC) message sent by the second access network node;
receiving, by the terminal, the first information sent by a first core network node corresponding to the second access network node, and obtaining the target parameter of the first bearer based on the first information; or
receiving, by the terminal, a first message for modifying the first bearer and sent by the first core network node corresponding to the second access network node, and obtaining the target parameter of the first bearer from the first message.

3. The communication method according to claim 2, wherein the receiving, by the terminal, a handover message sent by the first access network node, and obtaining the target parameter of the first bearer from the handover message comprises:
when an access stratum (AS) of the terminal determines, based on the handover message, that a target parameter of a first bearer corresponding to a target service has been obtained, transmitting, by a non-access stratum (NAS) stratum of the terminal, the target parameter of the first bearer to the IMS layer of the terminal; or
transmitting, by the AS stratum of the terminal, the target parameter of the first bearer obtained from the handover message to the NAS stratum, and transmitting, by the NAS stratum, the target parameter of the first bearer to the IS layer when the NAS stratum determines the first bearer to be a bearer corresponding to the target service.

4. The communication method according to claim 2, wherein the receiving, by the terminal, a redirection message sent by the first access network node, accessing the second access network node based on the redirection message, and obtaining the target parameter of the first bearer from a radio resource control (RRC) message sent by the second access network node comprises:
when an AS stratum of the terminal determines, based on the RRC message, that a target parameter of a first bearer corresponding to a target service has been obtained, transmitting, by a non-access stratum (NAS) stratum of the terminal, the target parameter of the first bearer to the IMS layer of the terminal; or
transmitting, by the AS stratum of the terminal, the target parameter of the first bearer obtained from the RRC message to the NAS stratum, and transmitting, by the NAS stratum of the terminal, the target parameter of the first bearer to the IMS layer when the NAS stratum of the terminal determines the first bearer to be a bearer corresponding to the target service.

5. The communication method according to claim 2, wherein the receiving, by the terminal, first information sent by a first core network node corresponding to the second access network node, and obtaining the target parameter of the first bearer based on the first information comprises:
receiving, by a NAS stratum of the terminal, the first information, obtaining the target parameter of the first bearer based on the first information, and transmitting the target parameter of the first bearer to the IMS layer.

6. The communication method according to claim 2, wherein the receiving first information sent by a first core network node corresponding to the second access network node comprises:
sending a location update request to the first core network node; and
receiving a location update acceptance message sent by the first core network node, wherein the location update acceptance message comprises the first information.

7. The communication method according to claim 6, wherein the location update request is a tracking area update (TAU) request or a registration request.

8. The communication method according to claim 2, wherein when the first information is used for determining by the terminal that the target parameter of the first bearer has changed, the obtaining the target parameter of the first bearer based on the first information comprises:
obtaining the target parameter of the first bearer from the handover message sent by the first access network node; or
obtaining the target parameter of the first bearer from the RRC message sent by the second access network node.

9. The communication method according to claim 2, wherein when the first information comprises the target parameter of the first bearer, the obtaining the target parameter of the first bearer based on the first information comprises:
obtaining the target parameter of the first bearer from the first information.

10. The communication method according to claim 2, wherein the receiving, by the terminal, a first message for modifying the first bearer and sent by the first core network node corresponding to the second access network node, and obtaining the target parameter of the first bearer from the first message comprises:
receiving, by a NAS stratum of the terminal, the first message and transmitting the target parameter of the first bearer in the first message to the IMS layer.

11. The communication method according to claim 2, wherein the redirection message is an RRC connection release message carrying a redirection indication.

12. The communication method according to claim 2, wherein the first core network node is an access and mobility management entity (MEME).

13. The communication method according to claim 1, wherein the determining whether a target parameter of a first bearer matches a parameter of an Internet protocol multimedia system (TMS) session comprises:
when the first bearer corresponds to a target service, determining, by the terminal, whether the target parameter of the first bearer matches the parameter of the IMS session.

14. The communication method according to claim 1, wherein the determining whether a target parameter of a first bearer matches a parameter of an Internet protocol multimedia system (IMS) session comprises:
determining, by the IMS layer of the terminal, whether the target parameter of the first bearer matches the parameter of the Internet protocol multimedia system (IMS) session.

15. The communication method according to claim 1, wherein the determining whether a target parameter of a first bearer matches a parameter of an Internet protocol multimedia system (TMS) session comprises:
determining whether the target parameter of the first bearer and the parameter of the IMS session meet a first condition; and
when the first condition is met, determining that the target parameter of the first bearer matches the parameter of the IMS session, or when the first condition is not met, determining that the target parameter of the first bearer does not match the parameter of the IMS session,
wherein the first condition comprises any one of the following:
whether an absolute value of a difference between the target parameter of the first bearer and the parameter of the IMS layer session is less than or equal to a first preset value;
the target parameter of the first bearer is equal to the parameter of the IS layer session; or
the difference between the target parameter of the first bearer and the parameter of the IMS layer session is a second preset value.

16. The communication method according to claim 1, wherein the moving from a first access network node to a second access network node comprises one of the following:
handing over from the first access network node to the second access network node; or
redirecting from the first access network node to the second access network node.

17. The communication method according to claim 1, wherein the first bearer is a bearer for transmitting a voice service or a video service;
the target parameter comprises at least one of the following:
a maximum bit rate (MBR); or
a guaranteed bit rate (GBR).

18. A terminal, comprising: a memory storing a computer program; and a processor coupled to the memory and configured to execute the computer program to perform operations comprising:
when the terminal moves from a first access network node to a second access network node, determining, by the terminal, whether a target parameter of a first bearer matches a parameter of an Internet protocol multimedia system (IMS) session; and
sending, by the terminal, a first message when the target parameter of the first bearer does not match the parameter of the IMS session, wherein the first message is used for requesting IMS session renegotiation,
wherein the first access network node belongs to N-th generation mobile communication technology, and the second access network node belongs to M-th generation mobile communication technology, wherein N is greater than M.

19. The terminal according to claim 18, wherein a manner of obtaining the target parameter of the first bearer comprises at least one of the following:
receiving, by the terminal, a handover message sent by the first access network node, and obtaining the target parameter of the first bearer from the handover message;
receiving, by the terminal, a redirection message sent by the first access network node, accessing the second access network node based on the redirection message, and obtaining the target parameter of the first bearer from a radio resource control (RRC) message sent by the second access network node;
receiving, by the terminal, the first information sent by a first core network node corresponding to the second access network node, and obtaining the target parameter of the first bearer based on the first information; or
receiving, by the terminal, a first message for modifying the first bearer and sent by the first core network node corresponding to the second access network node, and obtaining the target parameter of the first bearer from the first message.

20. A non-transitory computer-readable storage medium, storing a computer program, wherein the computer program, when executed by a processor, causes the processor to perform operations comprising:
when a terminal moves from a first access network node to a second access network node, determining, by the terminal, whether a target parameter of a first bearer matches a parameter of an Internet protocol multimedia system (IMS) session; and
sending, by the terminal, a first message when the target parameter of the first bearer does not match the parameter of the IMS session, wherein the first message is used for requesting IMS session renegotiation,
wherein the first access network node belongs to N-th generation mobile communication technology, and the second access network node belongs to M-th generation mobile communication technology, wherein N is greater than M.
